(19) United States
(12) Patent Application Publication
(10) Pub. No.: US 2016/0057246 A1
(43) Pub. Date: Feb. 25, 2016

(54) A method and a system for generating dynamic recommendations in a distributed networking system

(71) Applicant: Sumana Batchu Krishnaiahsetty, Bangalore (IN)

(72) Inventor: Sumana Batchu Krishnaiahsetty, Bangalore (IN)

(21) Appl. No.: 14/379,282

(22) PCT Filed: Mar. 15, 2013
(86) PCT No.: PCT/IB2013/052081

§ 371 Date: Aug. 15, 2014

(30) Foreign Application Priority Data
Mar. 16, 2012 (GB) 1204613.2
Mar. 21, 2012 (GB) 1204989.6
May 24, 2012 (GB) 1209168.2

(51) Int. Cl. H04L 29/08; G06Q 50/00; G06F 17/30

(52) U.S. Cl. CPC H04L 67/306; G06F 17/30312; G06F 17/30424; G06Q 50/01

(57) ABSTRACT

Embodiments of the present disclosure relate to a method and a system for generating dynamic recommendations in a distributed networking system. The present disclosure provides real time and contextual dynamic recommendations of information and transaction opportunities for needs identified using dynamic profiles of users. The dynamic recommendations are sorted by relevance using several key factors like connection strength, skill-fit-score, group affinity, Item-affinity, rater scores, location proximity etc. In an embodiment, the present disclosure relates to generating a health profile of a user in the distributed networking system. The method discloses predicting the possibility of a health disorder affecting a user based on health profiles of other users connected over the network.

### TECHNICAL FIELD

The present disclosure relates to a distributed networking system. In particular, the present disclosure relates to method and system to generating dynamic recommendations in a social networking system.

### BACKGROUND

Today, information plays an increasingly important role in the lives of people and businesses. The Internet has transformed how goods and services are bought and sold online.

Network operators and providers are spending enormous amounts of money and resources in infrastructure to support bringing more businesses online as it is more convenient and saves time. The Internet continues to serve as catalysts for processing information in new and different ways to reach millions of potential customers. On the consumer side, time and convenience can be valuable commodities. Hence it is important for them to see the most relevant transaction opportunities when transacting online. The present recommendation systems provide results based only on user queries. The recommendation results may not always be correct and may differ from user requirements. Also, the present recommendation systems do not facilitate recommendations based on the social connectedness of the provider of the transacted item with the prospective consumer.

There is an abundance of available time, skills and resources among the people which is not harnessed due to lack of visibility of opportunities. Similarly, organizations and people have ample tasks on hand that they are willing to outsource to aptly skilled people. Currently, there is no recommendation system which is designed to work as a repository of these opportunities and expedite matching the opportunities with relevant needs, available skills and resources. Further, no discovery and recommendation mechanism is being currently applied on a social networking mechanism.

Another area where information in a social network could be used effectively is in the area of predictive medical diagnosis. Predictive diagnosis of health disorders is very useful in alerting the patients about the health disorders so that they can take timely treatment and preventive steps to prevent or to at least contain the adverse effects of the health disorder. There is a lot of prior art in predictive diagnosis based on the patient's personal medical history. None of the prior art document uses health profiles of similar and socially connected users to predict the health profile for the said user.

In order to solve the above-mentioned problems, there is an increasing need to utilize information in a social network to improve the quality of life of individuals and to provide more effective mechanisms to generate recommendations.

### SUMMARY OF THE DISCLOSURE

The shortcomings of the prior art are overcome and many additional advantages are provided through the present disclosure. Additional features and advantages are realized through the techniques of the present disclosure. Other embodiments and aspects of the disclosure are described in detail herein and are considered a part of the claimed disclosure.

In order to solve the shortcomings of prior art, the proposed solution facilitates building a repository of transaction opportunities on a social networking platform, there by facilitating recommendation and sourcing of transaction partners based on the social connectedness and also based on recommendations from socially connected members.

In one embodiment, the present disclosure relates to a method for generating dynamic recommendations in a distributed networking system. The present disclosure details how contextual dynamic recommendations can be provided to users in a transaction enabled social networking environment, by allowing users to attach at least one of recommendation-needs, targeting-criteria and sort criteria to their transaction needs. Recommendation-needs helps in defining and controlling as to what kind of transactions like items, services, contests, etc. or entities like content, members, member-groups, etc. are recommended in the context of a transaction need. Targeting criteria defines who the audience for a transaction need should be, or what should be the context in which the transaction need is showcased. Finally, the sort criteria will allow the user to view and shortlist more relevant transactions, where relevance can include social connectedness of the provider of the transacted item.

The method comprises retrieving transaction needs along with associated recommendation needs of a user from a dynamic profile of the user. The term ‘transaction needs’ refers to both sale and buy needs, service offers and service needs, that a user might have. The dynamic profile is received by a central server of the distributed networking system from a client device associated with the user. The system then matches the transaction resources (which term is used to refer to various transaction needs from the dynamic profiles of a plurality of users) stored in a database of the networking system with the retrieved transaction needs. The method further comprises comparing the matched transaction resources with the recommendation needs to obtain the final transaction resources and sorting and optionally short-listing the final transaction resources based on one or more selected acquired profile attributes. Finally, the method comprises displaying the sorted transaction resources as dynamic recommendations on a user interface of the client device.

In one embodiment, the present disclosure relates to a distributed networking system to generate dynamic recommendations. The system comprises a central server connected to a plurality of client devices over a network. The central server comprises a database to store profile of a plurality of users. The central server further comprises a processor in communication with the database. The processor is configured to retrieve transaction needs along with associated recommendation needs of a user from a dynamic profile of the user. The dynamic profile is received by the central server from a client device associated with the user. The processor then matches transaction resources stored in a database of the networking system with the retrieved transaction needs. The processor is further configured to compare the matched transaction resources with the recommendation needs to obtain the final transaction resources and sort and optionally short-list the final transaction resources based on one or more selected acquired profile attributes. Finally, the processor displays the sorted transaction resources as dynamic recommendations on a user interface of the client device. The system also comprises the plurality of client devices wherein each of the client device comprises a user interface to display the sorted transaction resources as dynamic recommendations to the user.

In one embodiment, the present disclosure relates to a method for generating and recommending health profile attributes for a user based on the health profiles of a plurality of connected users in a distributed networking system. The method comprises retrieving a health profile of the plurality of connected users, said health profile comprises a plurality of attributes. Then, the method comprises matching the plurality of attributes of the health profile of connected users to determine one or more common attributes of the plurality of connected users. The method further comprises comparing a percentage occurrence of the common attributes of the plurality of connected users with a preconfigured threshold value. Finally, the method predicts the common profile attributes as one or more probable attributes of the health profile of the user upon determining that the occurrence of the common attributes among the plurality of users is exceeding the preconfigured threshold value. The predicted health profile attributes can then be presented to the user as part of dynamic recommendations.

In one embodiment, the present disclosure relates to a distributed networking system to generate a health profile of a user from health profiles of a plurality of users. The system comprises a central server connected to a plurality of client devices over a network. The system comprises a database to store profile of the plurality of users and a processor in communication with the database. The processor is configured to retrieve a health profile of the plurality of connected users from the plurality of client devices associated with the plurality of connected users, said health profile comprises a plurality of attributes. Then the processor matches the plurality of attributes of the health profile of the plurality of connected users to determine one or more common attributes of the plurality of connected users. The processor then compares occurrence of the common profile attributes of the plurality of users with a predetermined threshold value and predicts the common profile attributes as one or more probable attribute of the health profile of the user upon determining that the occurrence of the common attributes of the plurality exceeds the predetermined threshold value. The system also comprises the plurality of client devices, wherein each of the client device comprises a user interface to display the generated health profile attributes of a user.

The aforementioned and other features and advantages of the disclosure will become further apparent from the following detailed description of the presently preferred embodiments, read in conjunction with the accompanying drawings. The detailed description and drawings are merely illustrative of the disclosure rather than limiting, the scope of the disclosure being defined by the appended claims and equivalents thereof.

### BRIEF DESCRIPTION OF THE DRAWINGS

The features of the present disclosure are set forth with particularity in the appended claims. The embodiments of the disclosure itself, together with further features and attended advantages, will become apparent from consideration of the following detailed description, taken in conjunction with the accompanying drawings. One or more embodiments of the present disclosure are now described, by way of example only, with reference to the accompanied drawings wherein like reference numerals represent like elements and in which:

FIG. 1 illustrates a distributed networking system in accordance with an embodiment of the present disclosure;

FIG. 2 illustrates a flow-chart showing a method for generating dynamic recommendations using recommendation needs in accordance with an embodiment of the present disclosure;

FIG. 3 illustrates a flow-chart showing a method for generating dynamic recommendations using targeting criteria in accordance with an embodiment of the present disclosure;

FIG. 4 illustrates a flow-chart showing a method for generating health profile of a user in accordance with an embodiment of the present disclosure;

FIG. 5 illustrates a system showing the relation between transaction resources and needs in accordance with an embodiment of the present disclosure; and

FIG. 6 illustrates a network of users to determine link affinity in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

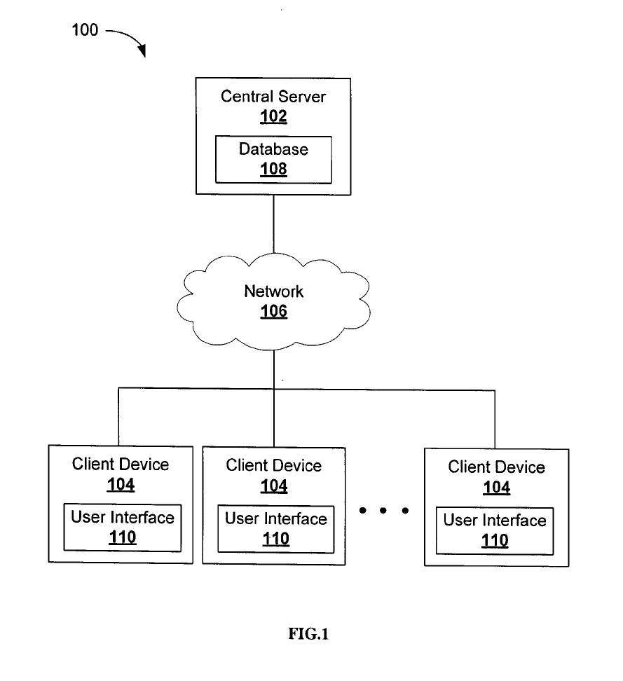

FIG. 1 illustrates a distributed networking system in accordance with an embodiment of the present disclosure. In an embodiment, the distributed networking system is a social networking system. The social networking system has a provision for the users to socially network amongst each other by establishing a one-to-one relationship of a specific type and/or forming groups based on shared profile attributes. The system comprises a central server 102, a plurality of client devices 104 and a network 106 connecting the central server 102 to the plurality of client devices 104. The central server 102 comprises a database 108. The client device 104 comprises a user interface 110. The user interface 110 is configured to input information from one or more users connected over the social network. Also the user interface 110 is configured to display one or more information.

Each user has a profile created on the social network. The database 108 is configured to store profile information of all the users connected to the network. The profile information comprises of a static profile, a dynamic profile and an acquired profile. The static profile comprises profile attributes that do not change or do not change much with time. The static profile attributes includes but is not limited to date of birth, skills, education and qualifications. Profile attributes of the dynamic profile are transient and are valid for a predefined period of time that dictates their relevance to the member. Beyond the validity period, the central server 102 notifies the user to either discard or reinstate the dynamic profile attribute. In case the user takes no action, a default action is performed by the central server 102 based on settings. Acquired profile refers to the profile acquired by a user by virtue of his/her existence in the network, and is usually an evolving one. The acquired profile is derived by the system, based on the connections of the user and transactions conducted by the user and user's connections, in the network 106. The acquired profile also includes attributes synthesized by the central server 102 through extrapolation, data-mining, etc. that are probabilistic and derived from profile data of other connected and/or similar users, their transaction data and network data. There can be several acquired profile attributes, and each of them has an algorithm to compute the value for a said user or between two specific users in the system. The acquired profile attributes can be used to define recommendation-needs, targeting-criteria and/or sort criteria for a given transaction resource.

In one embodiment, other entities in the network, such as user-group, item-traded, store, etc., can also possess acquired-profile attributes.

The acquired profile consists of various components including network related attributes, transaction related attributes and relationship related attributes. The network related attributes is based on connections of users. Examples include number of first and second-level of connections aggregated on type of connection, number of groups, clubs and communities attached to and the size of these groups, number of strong connections, where strength of connections is defined as number of transactions executed with a connection, where a connection can be user-to-user, user-to-groups or user-to-store/service-provider.

The transaction-related attributes comprise attributes like transactivity score (equal to number of transactions executed by the user), user rating accrued at the end of users' transactions.

The relationship attributes comprises system computed attributes that give a measure of relatedness of any two users or entities in the network. Examples of member-to-member relationship attributes include profile-affinity, link-affinity, skill-fit-score group-affinity, location-proximity, connection-strength and transaction-affinity. The transaction affinity is equal to number of transactions of a specific type conducted between two users. The skill-fit score gives the extent of match between desired skills for a transaction like service and possessed skills by a user. Member-to-item affinity could be defined as probability of a member's interest in an item based on number of members' connections who bought or showed explicit interest in that item, where an item could be shopping-item, service, content, etc. For example, a user's interest in a new model of 3D-TV would be higher if one or more users connected to the user have bought the TV. Item-to-item affinity could be based on catalogue-affinity and shopping-list-affinity of any two items.

The method used to compute the above-listed acquired profile attributes are defined below:
1. Connection strength between two users used for sorting recommendation of members, ex. fulfillers for services=number of transactions executed between the two users.
2. Transaction affinity=number of transactions of a given type executed between the entities, said transaction affinity is a component of connection strength.
3. Group affinity between two user used for sorting recommendation of members, ex. fulfillers for services=number of common groups between the users. The users being part of the same group also reflects profile affinity from shared interests.
4. Skill-fit-Score used for services=Score denoting the extent of match between the required skills for a service request and user's available skills. For the simplest implementation, it could just be a sum total of the available skills from the set of required skills. For example, if required skills are creative writing, animation and photography, then the skill fit score for a user having two of those skills would be two. The method can also be modified to include weights on a scale of 1 to 10 for required skills and proficiency level on a scale of 1 to 10 for available skills. The formula for the second case would be

Skill-fit-score=((WSm*PSm)+(WSn*PSn)+ . . . )/TWS,
where WSm, WSn, etc.=Weights of skills-available m, n, etc.
PSm, PSn, etc.=Proficiency-Level of skills-available m, n, etc.
TWS=Total sum of weights of skills-required=(WS1+WS2 . . . +WSn)
The required skills can also be marked as mandatory or optional, in which case the absence of a mandatory skill will result in a skill fit score of zero.
5. Item-affinity between items X, Y used for recommendations for items in rental-list, shopping-List, wish-list, recycle-list=Catalogue affinity+affinity as per transaction data.
   The catalogue affinity could be defined as the depth of sub-category that the items share in a hierarchical catalogue. The affinity as per transaction data can be defined as the number of times the two items appeared together in a shopping-List/order in percentage [=No. Of times items X and Y appear in the List/(Number of times Items X or Y appeared alone in the List)*100]
6. User-to-Item affinity=Number of connected members, who have bought the item, where a user is considered connected if there is a one-to-one connection with the said user or the two belong to the same group.
7. Location Proximity=Distance between the transacting parties.
8. Rater Score refers to the first default measure of the user/Entity-Rater. It is used for all recommendation sorts.
9. User's transactivity is defined as the number of transactions executed by the user on the website in a given period of time. It is a measure of how active a member is on the website.
10. Profile affinity=Number. of profile attributes that match between any two users.
11. Link affinity=Sum of all the path-strengths between two users for every unique path (breadth) between the user nodes, where path strength is the sum of connection strengths between the nodes in the path (depth) divided by the number of the nodes in the path (length of the path). FIG. 6 illustrates a network of users to determine link affinity. In the illustrated network below, assuming a connection strength of 1 between each or the nodes, the link affinity between nodes A and F=(1+1+1+1)/4+(1+1+1)/3=2.

As is evident from the above formulas, every transaction or network connection made on the network feeds into the acquired-profile of the users and other entities involved. Since the acquired profile attributes are evolving and are based on increasing amount of data, these attributes get better at depicting user preferences and behavior. This results in improving the quality and relevance of dynamic recommendations made, since acquired profile attributes can be used to define recommendation-needs, targeting-criteria and/or sort criteria for transaction-needs.

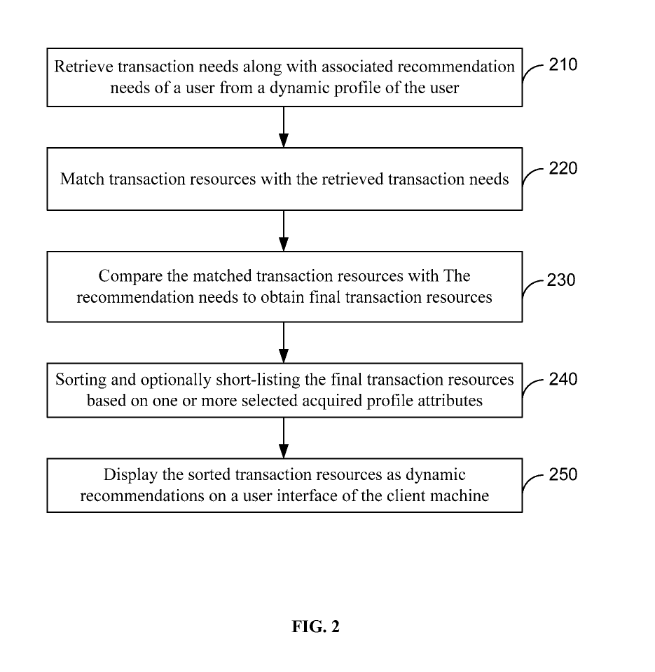

FIG. 2 illustrates a flow-chart showing a method for generating dynamic recommendations using recommendation needs in accordance with an embodiment of the present disclosure. The method comprises retrieving transaction needs along with associated recommendation needs of a user from a dynamic profile of the user at step 210.

In an exemplary embodiment, the transaction needs could be requirement for an item or a service by a user. The dynamic profile is received by the central server 102 of the social networking system from a client device 104 associated with the user. In an embodiment, the user inputs the transaction needs and the recommendation needs into the client device 104.

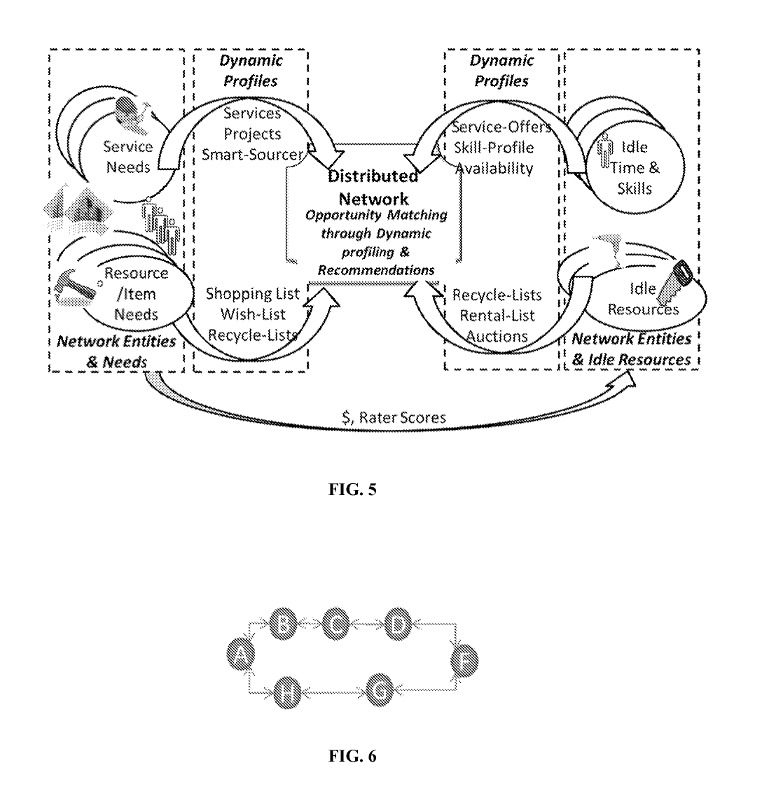

Then, transaction resources stored in a database of the networking system are matched with the retrieved transaction needs at step 220. The relation between transaction needs and transaction resources is explained in FIG. 5. The social networking system comprises a plurality of users associated with the client devices 104. The users can be capable of providing a resource or fulfilling need for items or fulfilling service needs. These users shall be connected to plurality of other users who may require a resource, an item or a service. Thus, the present disclosure provides a platform to facilitate transactions in a networked environment. The system is designed as a repository of opportunities and matches them with available skills and resources.

Then at step 230, the matched transaction resources are compared with the recommendation needs to obtain the final transaction resources. In one embodiment, the recommendation needs can be defined at transaction type level like all service needs have service offers and shopping items as recommendation needs. In another embodiment, each instance of transaction need e.g. a shopping item called ‘Dishwasher’, a service-need called ‘Carpet cleaning’, etc. can be linked to a set of ranked recommendation needs/criteria consisting of recommendation entities and optionally their attributes, keywords and tags, so as to enable dynamic recommendation of recommended entities in the context of the current entity, based on matching of the values of the current entity's attributes, keywords and tags in an instance with that of recommended-entities' attributes, keywords and tags, in the particular instance of the recommended-entity. In other words, the recommendation need can be either a type of recommendation entity needed or can be further qualified by attaching values to the entity attributes. For example, type of recommendation entity could include but is not limited to information, advertisements, physical items, electronic items, services, service providers, events, surveys, polls and similar transactions offered and/or needed by users in the distributed networking system including connected users and connected users with similar recommendation needs. An example for a case where recommendation entity can include attribute level values would be when recommendation entity is a physical item, and is further qualified by saying physical item's value should be in the range of like $10 to $20. The recommendation needs may also include brand names of items, service providers, cost range, location etc. The recommendation needs attached to a transaction need can be optionally ranked to indicate the relative importance of each need. Recommendation needs/criteria and its ranking can be overridden in the instance of an entity by the user and system administrator and user as permitted by the defined access-privileges, to further refine and contextualize the recommendations.

Finally, at step 240, final transaction resources sorted and optionally short-listed based on one or more selected acquired profile attributes. The acquired profile attributes are system computed based on at least one of historical transactions like connection-strength, transaction-affinity etc., user relationship information like link-affinity, group-affinity etc., user profile information like profile-affinity, location proximity etc. and user preferences like favorite listing, subscription data, rating data etc., so as to give a measure of the relatedness of the given user with respect to the provider of the transacted item. This helps users to choose transaction partners that are more socially connected, leading to net-sourcing which is a special case of crowd-sourcing.

The final transaction resources can also be sorted based on recommendation score. The recommendation score is a measure of match of a recommended entity as per the defined recommendation criteria for the smart-tool, expressed as a percentage.

Recommendation Score=Number of matching recommendation needs for a recommended entity/Total number of recommendation needs defined for a smart-tool*100

This score can be further modified for precision by using the ranks attached to each recommendation need and/or criteria as a weight for its relevance. So, weighted-recommendation score will be defined as,

Recommendation-score(weighted)=sum of (RMm+RMn+ . . . )/(R1+R2+Rfinal)*100

where RMm, RMn, etc. are the ranks of a matched recommendation criteria ‘m’, ‘n’, etc. and
R1, R2, . . . , Rfinal denote the ranks of all the recommendation criteria identified.

Finally, the sorted transaction resources are displayed as dynamic recommendations on a user interface of the client device at step 250. The dynamic recommendations can also be delivered asynchronously through e-mails, if so opted by users.

In an embodiment, the transaction resources recommended can be qualified with a list of users from the requesting users network connections who have either availed and/or rated the transacted item. This allows the users to make a socially influenced choice of transaction partner leading to net-sourcing, which is a special case of crowd-sourcing.

The method of the present disclosure comprises means to allow a networking user to associate a comment with an offered or desired transaction from another networking user and then forward the commented transaction to one or more networking users as a recommendation. The recommendation is qualified with a unique system generated recommendation ID (identification) that enables tracing of provider, recommender and prospective consumer of the transaction, thus enabling release of any recommendation benefits to the recommender and/or consumer of the recommended transaction

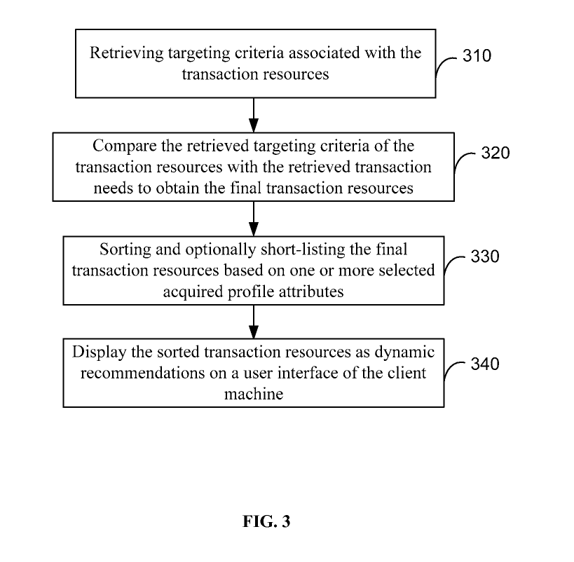

FIG. 3 illustrates a flowchart showing a method for generating dynamic recommendations using targeting criteria in accordance with an embodiment of the present disclosure. Each transaction resource can be configured to link to possible target entities including target user profiles based on configurable targeting criteria. This feature is useful to target advertisements, items and other transactions like surveys, polls, services, projects, sale-list items, etc. to users based on the criteria defined by the owner of transaction resources or advertiser.

Each transaction resource including but not limited to sale-lists and their items, surveys, polls, contest, events, content, advertisements, members, member-groups, and member-connections can be linked to a set of ranked targeting criteria consisting of target entity-types and their attributes, keywords and tags, either at the entity-level or entity's attribute level, for the purpose of enabling dynamic recommendations of the current entity in the context of the target-entity's instance. Based on matching of values of the entity's attributes, keywords and tags in an instance with that of target-entities' attribute values, keywords and tags, in the particular instance of the target-entity, the central server 102 automatically generates dynamic recommendation of the current entity in the context of the target entity. Such recommendations could be that of information and transaction opportunities and will be semantically rich, context sensitive and relevant.

Each target entity identified by the targeting criteria will be qualified by a targeting score that denotes the extent of match between an entity's targeting criteria and the targeted entity. It is equal to number of matching target criteria divided by the actual number of defined criteria expressed as a percentage.

Targeting-Score=(No. of matching target criteria for a given target entity)/(Total number of target criteria defined for a smart-tool)*100

This score can be further improved for precision by using the ranks attached to each targeting criteria as a weight for its relevance. So weighted-targeting-score will be defined as,

Targeting-score(weighted)=sum of (RTm+RTn+ . . . )/(R1+R2+ . . . Rfinal)*100

Where RTm, RTn, etc. are the ranks of matched target criteria ‘m’, ‘n’, etc. and R1, R2, . . . , Rfinal denote the ranks of all the target criteria identified.

Also, users can control the targeting of transactions such as services, projects, surveys, etc. to them based on subscription options chosen by them so as to opt-in or out of specific categories and sub-categories of transactions and optionally other dynamic recommendations.

The method comprises retrieving targeting criteria associated with the transaction resources at step 310. Then, the retrieved targeting criteria of the transaction resources is compared with the retrieved transaction needs to obtain the final transaction resources at step 320. At step 330, the final transaction resources sorted and optionally short-listed based on one or more selected sort-criteria that can include acquired profile attributes or targeting-score. Finally, at step 340, the sorted transaction resources are displayed as dynamic recommendations on a user interface of the client device 104.

An example for dynamic recommendations is explained below. When a user adds a Tablet-PC on to smart wishlist, the user gets to see recommendations panel on the user interface 110 with different tabs as given below, based on recommendation-needs/criteria configured. Typically, there will be one tab for each type of recommended entity as per configuration. One tab for advertisements that can include similar items from on-line stores, insurers, financers, etc. affiliated to website along with offers, as per targeting criteria of the advertisement sorted by targeting-score. Another tab is provided for displaying search results for content on ‘Tablet-PCs’ on the website. Another tab is provided for displaying similar items from lists like sale-lists, recycle-lists, auction-list, etc. of connected members.

Another example of dynamic recommendation is illustrated below. When a user adds a service-need like broadband connection, magazine subscription, gardening, etc. into the service-needs-list, the dynamic recommendations of the present disclosure could recommend at least one of advertisements of service providers, insurers, etc., list of relevant service offers with details of providers with rates, terms and conditions from service offers of other members' dynamic profile. The list of providers is ordered by link affinity and connection strength. Also, the recommendations could be other connected users with similar service needs and content search results like text, videos, audios, etc. relevant to the kind of service requested by the user.

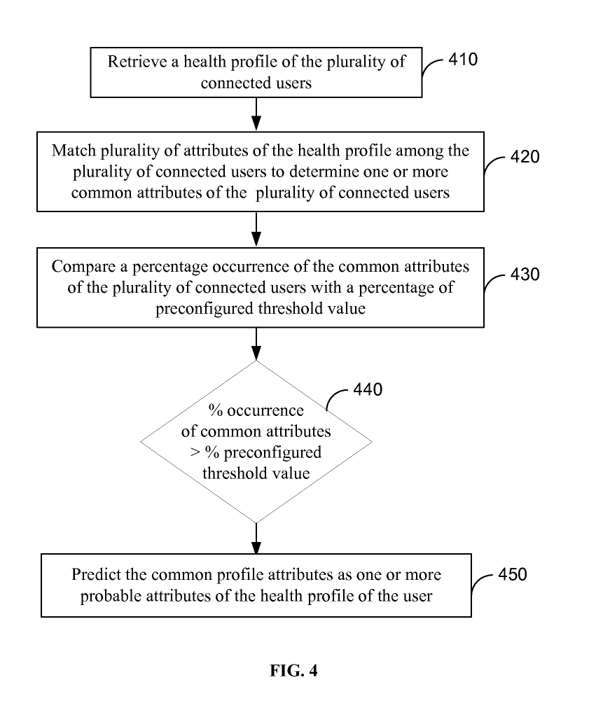

FIG. 4 illustrates a flow-chart showing a method for generating health profile of a user in accordance with an embodiment of the present disclosure. The method predicts a user's probability of having a specific health characteristic based on health-profile of socially connected users and relatives of the user In another embodiment, a health profile attribute is predicted for a user based on similar users' health profile, where the similarity is determined by shared profile attributes like same profession, location-proximity, organization working-for, etc. The present disclosure makes the health profile prediction possible for a user, while allowing all users concerned to maintain the privacy of their health profile.

The method comprises securely retrieving a health profile of the plurality of connected users at step 410. The plurality of users can be connected to the user by relation-types that could comprise but not limited to family members, colleagues, neighbors, etc. Also, the plurality of users could be connected to the user by forming groups based on shared profile-attributes including but not limited to interests, skills, location, profession, organization working-for. Further, in one embodiment, the plurality of users are considered connected if they are on the same distributed network and have at least one common profile attribute with respect to that of the said user, that includes but not limited to interests, skills, location, profession, organization working-for, same transactions, etc. The health profile comprises a plurality of attributes. At step 420, the attributes of the health profile of the plurality of connected users are compared to determine one or more common health profile attributes among the plurality of connected users. Then, a percentage occurrence of the common attributes of the plurality of connected users is compared with a preconfigured threshold value at step 430. The percentage of preconfigured threshold value can be different for each type of attribute of the health profile and is configurable by a system administrator. Further the threshold level can be modified to more appropriate levels, as there is more statistical data from a website like this, so that the predictive capability of the system can be improved with time.

The attributes of health profile could be health disorders optionally qualified by probability of health disorders and related symptoms with weights, where weights denote the extent of correlation of a symptom with the health disorder, and symptoms not yet related to health disorders. If the occurrence of the common attributes among the plurality of users is exceeding the preconfigured threshold value at step 440, the common profile attributes is predicted as one or more probable attributes of the health profile of the user at step 450. The predicted health profile attribute is qualified by a probability that is a function of the number of occurrences of the attribute in the plurality of the connected users.

In an embodiment, the type of health disorder being predicted for a user determines what relation type is used to get the connected users, which decision is aided by a mapping table that maps the health disorder type to a relation type. Types of health-disorders could be identified by categories like hereditary, chronic, contagious/epidemic, seasonal, occupational hazard, environmental hazard, etc. Dynamic recommendations can use this information to predict the possibility of disorder affecting other users or the said users at a different time based on shared family relations, location proximity, occupation, environment, etc.

The method of the present disclosure allows for recording two levels of health profile attributes including diagnosed health-condition at the higher and set of related symptoms at the lower level. Recording of the two level health profile attributes is aided by dictionary maintained in the central server 102, relating symptoms to health-conditions with a weightage factor qualifying the correlation of the symptom to health-condition. When only symptoms or health-conditions are recorded, the other information can be inferred or derived or recommended by the system using the dictionary, an expert system for diagnosis and based on the data available.

Dynamic recommendations for a health-profile can also be in the form of support groups for the particular health issue, clinical trial opportunities, members of family with similar health issues, advertisements of medicines, service providers, equipment, books, multimedia, online merchandise, etc. related to the health-disorder.

The method of the present disclosure proactively suggests probability of a particular genetically inherited health issue in a user based on family history of diagnosed issues. Such a derived diagnosis can be added to the specific health profile to enable proactive measures to tackle the health issues. The proactive alerts could also be probability of allergies to specific drugs and other allergens based on family history of the same

In an embodiment, for chronic diseases like asthma that have seasonal variations or are location sensitive, the method of the present disclosure transmits proactive alerts to the user to the possibility of an instance, depending on the time of the year and previous history of health-issue during the period and the current location of the user.

Further, in another embodiment, the probability of user getting infected by an epidemic could be determined as a function of the number of infected users in the vicinity of the user and also based on the number of connections the said user has with infected users.

Another non-limiting example of the how the methods disclosed herein can be used to predict health profile attributes. Occupational exposure is a common cause of lead poisoning in adults. Although lead poisoning is a known hazard, there is no known safe threshold for lead exposure. According to one estimate, in the Unites states alone, more than 3 million workers are exposed to lead at workplace. Lead poisoning can lead to a variety of symptoms that can be subtle and difficult to attribute to lead poisoning. Symptoms could range from headaches to convulsions, from abdominal pain to kidney failure. However, when there is statistical data supporting evidence of lead poisoning, the diagnosis, treatment and preventive actions are easier to effect. The current invention allows such inference by comparing the health profile of workers working in similar work-environment and then predicting common health attributes as probable health disorder for the group of users. Similarly, users can be alerted to other health hazards stemming from industrial pollution, natural causes like volcanic ash, allergic pollen, etc., based on the number of occurrences of the symptoms in a given segment of users.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In addition, where features or aspects of the disclosure are described in terms of Markush groups, those skilled in the art will recognize that the disclosure is also thereby described in terms of any individual member or subgroup of members of the Markush group.

Many variations of the invention and embodiments herein described will be apparent to people skilled in the art. For example, features of the different embodiments disclosed herein may be omitted, selected, combined or exchanged in order to form further embodiments. Again, where a preference or particularisation is stated, there is implicit the possibility of its negative, i.e. a case in which that preference or particularisation is absent. The invention is considered to extend to any new and inventive embodiments formed by said variations, further embodiments and cases, without deviation from scope of the invention.

The various aspects and embodiments disclosed herein are for purposes of illustration and are not intended to be limiting, with the true scope and spirit being indicated by the following claims.

1. A central server connected to a plurality of client devices that is adapted to generate dynamic recommendations comprising:
a memory that comprises a database that stores profiles of a plurality of users;
a processor in communication with the database and the plurality of client devices, wherein said processor is configured to execute at least one of (i) a first set of instructions and (ii) a second set of instructions,
wherein said first set of instructions when executed by said processor causes:
retrieving transaction needs along with associated recommendation needs of a user from a dynamic profile of the user, wherein the dynamic profile is received from a linked storage device or a client device associated with the user, wherein the transaction needs are configured at a user level, wherein the recommendation needs are configured at at least one of a server level for a type of transaction and at a user-level for an instance of a transaction;
matching transaction resources stored in a database of networking system with the transaction needs that are retrieved from the dynamic profile of the user to obtain matched transaction resources, wherein the transaction resources comprise transaction needs from dynamic profiles associated with a plurality of users; and
comparing the matched transaction resources with the recommendation needs to obtain a first set of final transaction resources;
wherein said second set of instructions when executed by said processor causes:
(i) retrieving targeting criteria associated with the transaction resources at the server level for a type of transaction and at a user level for an instance of a transaction from the database of the networking system; and
(ii) comparing the targeting criteria with a profile of the user to obtain a second set of final transaction resources, and
wherein said processor is further configured to execute a third set of instructions, wherein said third set of instructions when executed by said processor causes:
transmitting to a client device, a subset of final transaction resources that is from at least one of the first set of final transaction resources and the second set of final transaction resources.

2-28. (canceled)

29. The central server of claim 1, wherein the processor in communication with the database is further configured to:
retrieve health profiles of a plurality of connected users connected to the user in the networking system, the health profiles comprising a plurality of attributes;
match the plurality of attributes of the health profiles of the connected users to determine one or more attributes common to the plurality of connected users;
compare percentage occurrence of the common attributes of the plurality of connected users with a preconfigured threshold value for the attributes; and
predict common profile attributes as one or more probable attributes of a health profile of the user upon determining that the percentage occurrence of the common attributes among the plurality of connected users is exceeding the preconfigured threshold value for the attributes.

30. The central server of claim 29, wherein the plurality of connected users are connected to the user using at least one of a relation type selected from a predefined set of relation-types.

31. The central server of claim 30, wherein the plurality of connected users are connected to the user by forming groups based on shared profile attributes comprising (i) interests, (ii) skills, (iii) location, (iv) organization working for and (v) profession.

32. The central server of claim 1, wherein a plurality of users on the networking system are considered as connected to the user upon determining that the plurality of users have at least one profile attribute in common with the user.

33. The central server claim of claim 32, wherein the processor in communication with the database is further configured to recommend a relation between two users by determining a common user from the plurality of users being connected to each of the two users.

34. The central server of claim 29, wherein the plurality of attributes of the health profiles comprise health disorders, probability of health disorders and related symptoms with weights and symptoms not yet related to health disorders.

35. The central server of claim 29, wherein a predicted health profile attribute is qualified by a probability that is a function of the percentage of occurrences of the attributes in the plurality of the connected users and predefined sub-attributes of a health profile attribute that is predicted.

36. The central server of claim 29, wherein the processor in communication with the database is further configured to associate a category of health profile attributes to particular relation types and profile attributes that determine the connected users to be considered for predicting the health profile attributes belonging to the category of health profile attributes.

37. The central server of claim 29, wherein the processor in communication with the database is further configured to:
obtain attributes associated with the health profile of the user comprising diagnosed health conditions and symptoms related to the diagnosed health conditions;
retrieve weightage factors qualifying a correlation of the symptoms and health conditions from the database; and
predict (a) symptoms when health conditions of the user are available or (b) health conditions of the user when symptoms are available based on a predefined threshold weightage factor.

38. The central server of claim 37 further configured to add the health profile that is predicted to a profile of the user based on at least one of a predefined threshold probability and a user action.

39. The central server of claim 1, wherein the dynamic recommendations are used by the user to conduct a transaction.

40. The central server of claim 1, wherein a profile associated with each user of the plurality of users comprises (i) a static profile, (ii) a dynamic profile, and (iii) an acquired profile.

41. The central server of claim 40, wherein the profile associated with the user comprises a location attribute.

42. The central server of claim 40, wherein the dynamic profile of the user comprises a semantic dimension based on a purpose of a smart tool which is used to define at least one of transaction needs, recommendation needs and target criteria; and wherein a smart tool is an application deployed on at least one of the central server and the client devices, that facilitates a particular type of transaction.

43. The central server of claim 40, wherein attributes of the dynamic profile of the user have a finite validity period, wherein executing the one or more sequences of instructions further causes:
communicating a notification to a user device to reinstate or deactivate the attributes of the dynamic profile on expiry of the finite validity period; and
performing a predefined default action in absence of a user action.

44. The central server of claim 40, wherein attributes of the acquired profile of the user evolve based on transactions conducted by the user on the networking system and comprises at least one of (i) historical transactions, (ii) user relationship information, (iii) user profile information, and (iv) preferences of the user.

45. The central server of claim 1, wherein the recommendation needs are input into the dynamic profile and ranked for each type of transaction by a system administrator and for each instance of a transaction, by the user, to control types of recommendations received in a context of that recommendation need.

46. The central server of claim 1, wherein the targeting criteria for each type of transaction are defined and ranked by a system administrator and targeting criteria for each instance of a type of transaction are defined and ranked by the user to control a context in which a transaction is recommended.

47. The central server of claim 1, wherein the networking system is a social networking system and wherein the dynamic recommendations are obtained from transaction resources and profile attributes of connections associated with the user in the social networking system.

48. The central server of claim 47, wherein the connections associated with the user are determined from a plurality of users based on attributes of the acquired profile of the user that comprises at least one of a link-affinity, a group-affinity, a profile-affinity and a connection strength.

49. The central server of claim 1, wherein at least one of the recommendation needs, targeting criteria and sort criteria comprises attributes of the user including static, dynamic and acquired profile attributes.

50. The central server of claim 1, wherein the dynamic recommendations are generated for a partial dynamic profile of a user; wherein the partial dynamic profile of the user is provided by a client device associated with the user based on a current transaction-need being viewed by the user on the client device.

51. The central server of claim 50, wherein the dynamic recommendations generated for the partial dynamic profile are transmitted to the client device; wherein the client device presents the dynamic recommendations in a context of the partial dynamic profile.

52. The central server of claim 1, wherein the dynamic recommendations that are recommended to a user, comprising transaction resources from a plurality of categories of transactions; are controlled by the user through a subscription process that allows the user opt-in and opt-out of specific categories of transactions.

53. The central server of claim 1, wherein the dynamic recommendations comprise at least one of advertisements, physical items, electronic items, services, service providers, events, surveys, contests, content, members, member groups, polls and similar transactions offered or needed by users in the networking system comprising connected users and users with similar recommendation needs.

54. The central server of claim 1, wherein matching transaction resources on the networking system with the transaction needs comprises matching (i) attributes, attribute-values, keywords and tags of the transaction resources with (ii) attributes, attribute-values, keywords and tags of the transaction needs of the user.

55. The central server of claim 54, wherein attributes of the transaction resources are selected from a configurable list comprising at least one of (i) attributes of a transacted item, and (ii) attributes of a provider of the transacted item.

56. The central server of claim 40, wherein the acquired profile is built for groups of users in the networking system.

57. The central server of claim 40, wherein the acquired profile is built for the transaction resources.

58. The central server of claim 1, wherein the transaction resources recommended are qualified based on a plurality of users connected to the user in the networking system having at least one of (i) availed and (ii) rated transacted resources.

59. The central server of claim 58, wherein the transaction resources are recommended by a user to one or more connected users.
